(19) United States
(12) Patent Application Publication
(10) Pub. No.: US 2022/0095411 A1
(43) Pub. Date: Mar. 24, 2022

(54) Methods and Apparatus for Signalling Transmission in L2 UE-to-Network Relay Operation

(71) Applicant: MediaTek INC., Hsin-Chu (TW)

(72) Inventors: Guan-Yu Lin, Hsin-Chu (TW); Xuelong Wang, Beijing (CN); Nathan Edward Tenny, San Jose, CA (US)

(21) Appl. No.: 17/484,257

(22) Filed: Sep. 24, 2021

Related U.S. Application Data
(63) Continuation-in-part of application No. PCT/CN2020/116753, filed on Sep. 22, 2020.

(30) Foreign Application Priority Data
Sep. 22, 2020 (CN) PCT/CN2020/116753
Sep. 15, 2021 (CN) 2021111080268.7

(51) Int. Cl. H04W 76/27; H04W 76/14; H04W 80/02

(52) U.S. Cl. CPC H04W 76/27; H04W 92/18; H04W 80/02; H04W 76/14

(57) ABSTRACT

Apparatus and methods are provided to support SRB0 transmission for L2 UE-to-NW relay. In one novel aspect, the SRB0 message includes remote UE ID by the remote UE or relay UE during forwarding the SRB message. In one novel aspect, when perform SRB0 transmission over PC5 interface, the relay UE and remote UE apply default bearer/default RLC channel for SRB0 transmission. In one novel aspect, the relay UE and base station exchange the forwarded UL SRB0 message and DL SRB0 message via contained of RRC message over UL-DCCH and DL-DCCH separately. In one novel aspect, the message in response to the transmission of SRB0 from the remote UE further includes C-RNTI for the remote UE if this remote UE is initiating RRC Setup or RRC Resume procedure.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2020/116753, entitled “Methods and Apparatus for Signalling Transmission in L2 UE-to-Network Relay Operation,” filed on Sep. 22, 2020. This application is a continuation-in-part of International Application No. PCT/CN2020/116753. International Application Number PCT/CN2020/116753 is pending as of the filing date of this application, and the United States is an elected state in International Application No. PCT/CN2020/116753. The disclosure of each of the foregoing documents is incorporated herein by reference.

### TECHNICAL FIELD

The disclosed embodiments relate generally to wireless communication, and, more particularly, to enable the signaling transmission between the Remote UE and the gNB to establish an end-to-end connection towards the network via Layer 2 UE-to-Network relay.

### BACKGROUND

To support sidelink relay, there are two kinds of UE-to-Network Relay architecture, i.e. Layer 2 relay (L2 relay) and Layer 3 relay (L3 relay).

L3 based Sidelink Relay UE forwards data packet flow of the Remote UE as IP traffic as a general Router in data communication network. The IP traffic based forwarding is conducted in a best efforts way. For L3 UE-to-Network Relay, there exist both SLRB s over PC5 and Uu Radio Bearers to carry the QoS flows established between Remote UE and 5GC. L3 UE-to-Network Relay can support flow based mapping at SDAP layer when converting PC5 flow to Uu Flow, or vice versa, during traffic forwarding. Note that since L3 based Sidelink Relay UE works like an IP router, remote UE is transparent to the base station, i.e., the base station cannot know whether the traffic transmitted by a relay UE originates from this relay UE itself, or originates from a remote UE but is forwarded by this relay UE.

In contrast, in case of L2 based SL Relay, relaying is performed above RLC sublayer via Relay UE for both CP and UP between Remote UE and network. Uu SDAP/PDCP and RRC are terminated between Remote UE and gNB, while RLC, MAC and PHY are terminated in each link (i.e. the link between Remote UE and UE-to-Network Relay UE and the link between UE-to-Network Relay UE and the gNB).

An adaptation layer over RLC layer is supported in Uu to perform bearer mapping and it can be also placed over PC5 to perform bearer mapping at sidelink. The adaptation layer between the Relay UE and gNB is able to differentiate between bearers (SRBs, DRBs) of a particular Remote UE. Within a Uu DRB, different Remote UEs and different bearers of the Remote UE can be indicated by additional information included in adaptation layer header. Unlike in L3 relay, in L2 relay the base station is aware of each remote UE, and thus before the relay UE starts to forward normal data traffic, the end-to-end connection between a remote UE and the base station should be established first. After establishing the RRC connection via SL relay, the remote UE can then forward data traffic based on the established bearers and the forwarding/router information carried in adaptation layer.

Currently, an open question for L2 connection setup procedure is that how the remote UE sends its first message to initiate the following SL transmission before the end-to-end connection is established.

Remember that in NR Uu, the message for a UE to initiate transmission with the base station is known as SRB0 message. SRB means signaling radio bearer, and SRB0 message is used to carry essential signaling before RRC connection is established. The SRB0 message in NR Uu includes the message for a UE to establish/resume/re-establish a RRC connection, or to request for required system information on demand (only for a UE in RRC_IDLE or RRC_INACTIVE). In NR Uu, UE initiate the transmission of the SRB0 message to the base station to start the procedure for RRC connection management or for system information request.

In contrast to NR Uu SRB0 transmission, in L2 SL relay, the remote UE should send SRB0 message to the base station via the forwarding relay UE. With the involvement of relay operation, additional design is required to ensure. For example, SRB0 of the remote UE should be able to be forwarded to the base station even before the bearers for Uu traffic forwarding (PC5 interface between remote UE and relay UE, and Uu interface between relay UE and the base station) of this relay UE are established. Besides, base station should be able to provide the response to the correct remote UE, e.g., if a remote UE sends SRB0 message to initiate RRC connection setup via SL relay, the gNB should be able to send the RRCSetup message back to this remote UE who initiates the request.

A solution is sought.

### SUMMARY

A method is provided to support remote UE transmitting SRB0 message for Layer 2 UE-to-NW SL relay. In one novel aspect, the SRB0 message includes remote UE ID by the remote UE or relay UE during forwarding the SRB message. In one novel aspect, when perform SRB0 transmission over PC5 interface, the relay UE and remote UE apply default bearer/default RLC channel for SRB0 transmission. In one novel aspect, the relay UE and base station exchange the forwarded UL SRB0 message and DL SRB0 message via contained of RRC message over UL-DCCH and DL-DCCH separately. In one novel aspect, the message in response to the transmission of SRB0 from the remote UE further includes C-RNTI for the remote UE if this remote UE is initiating RRC Setup or RRC Resume procedure. In one novel aspect, if this remote UE intends for on-demand system information request, and the base station has the flexibility to provides system information via broadcast, additional signaling should be introduced to indicate to the relay UE what system information should be forwarded to the remote UE.

### BRIEF DESCRIPTION OF THE DRAWINGS

The accompanying drawings, where like numerals indicate like components, illustrate embodiments of the invention.

FIG. 1 is an exemplary signaling flow for a remote UE to transmit SRB0 ti the network and receives response to SRB0 from the network via L2 relay.

FIGS. 2(a), 2(b), and 2(c) illustrate designs of signaling flow for a remote UE to perform on-demand system information request via L2 UE-to-NW relay.

FIGS. 3(a), 3(b), 3(c), and 3(d) illustrates the signaling flow for the base station to reconfigure each relay link to support end-to-end QoS requirement.

FIG. 4A illustrates a wireless cellular communications system supporting signaling transmission in L2 UE-to-network sidelink relay for a remote UE via a relay UE in accordance with a novel aspect.

FIG. 4B is a simplified block diagram of a wireless transmitting device and a receiving device in accordance with embodiments of the current invention.

FIG. 4C illustrates one embodiment of using a specified/fixed/default configuration to transmit and receive SRB0 in accordance with one novel aspect.

FIG. 4D illustrates one embodiment of SRB0 transmission for remote UE in connected mode to request system information in accordance with one novel aspect.

FIG. 5 illustrates one embodiment of SRB0 transmission for remote UE in idle mode to request system information in accordance with one novel aspect.

FIG. 6 illustrates one embodiment of SRB0 transmission for remote UE with remote UE ID determined by either by remote UE or by relay UE.

FIG. 7 illustrates one embodiment of PC5 RLC channel configuration and DRB configuration for remote UE after connection establishment.

FIG. 8 illustrates a layer 2 (L2) sidelink (SL) relaying architecture for UE-to-network relay in accordance with one novel aspect.

FIG. 9 is a flow chart of a method of SRB0 transmission and reception in L2 UE-to-network relay in accordance with one novel aspect.

FIG. 10 is a flow chart of a method of system information acquisition for a remote UE in L2 UE-to-network relay in accordance with one novel aspect.

FIG. 11 is a flow chart of a method PC5 RLC channel configuration and DRB configuration for a remote UE after connection establishment.

### DETAILED DESCRIPTION

Reference will now be made in detail to some embodiments of the invention, examples of which are illustrated in the accompanying drawings.

In L2 relay, a relay UE only serves as a hop-by-hop RLC-level router, and thus before data traffic forwarding, a remote UE should establish an end-to-end connection with the base station via SL relay to create the corresponding end-to-end Uu SDAP/PDCP layer for QoS flow/bearer handling and RRC layer for control plane.

In L2 relay, if a remote UE is not RRC_CONNECTED via SL relay, the remote UE cannot directly send its data traffic. Instead, similar to NR Uu, the remote UE is only allowed to send SRB0-like message before UE enter RRC_CONNECTED. SRB is abbreviation of signaling radio bearer.

In NR Uu, SRB0 is for RRC messages using the CCCH (common control channel) logical channel. A UE will send an UL SRB0 message in the following cases: for establishing a RRC connection (RRCSetupRequest), for resuming a RRC connection (RRCResumeRequest), for re-establishing a RRC connection (RRCReestablishmentRequest), or for on-demand system information request (RRCSystemInfoRequest).

In L2 relay, similar to NR Uu a remote UE has the requirement to maintain a RRC connection (e.g. for setup, for resume, for reestablishment) and to request required system information. However, since in L2 SL relay the SRB0 message is transmitted to the base station via the forwarding of SL relay UE, additional mechanism should be introduced to ensure successful relay. For example, introduce mechanisms to ensure that SRB0 message can be forwarded to the base station correctly (e.g. using the suitable bearer or logical channel to send this SRB0 message on both links, i.e. the PC5 link between remote UE and relay UE, and the Uu link between the relay UE and the base station). For example, introduce mechanisms to ensure that the remote UE can receives the response message from the base station correctly (e.g. correct bearer mapping and routing in the downlink direction over Uu link and PC5 link).

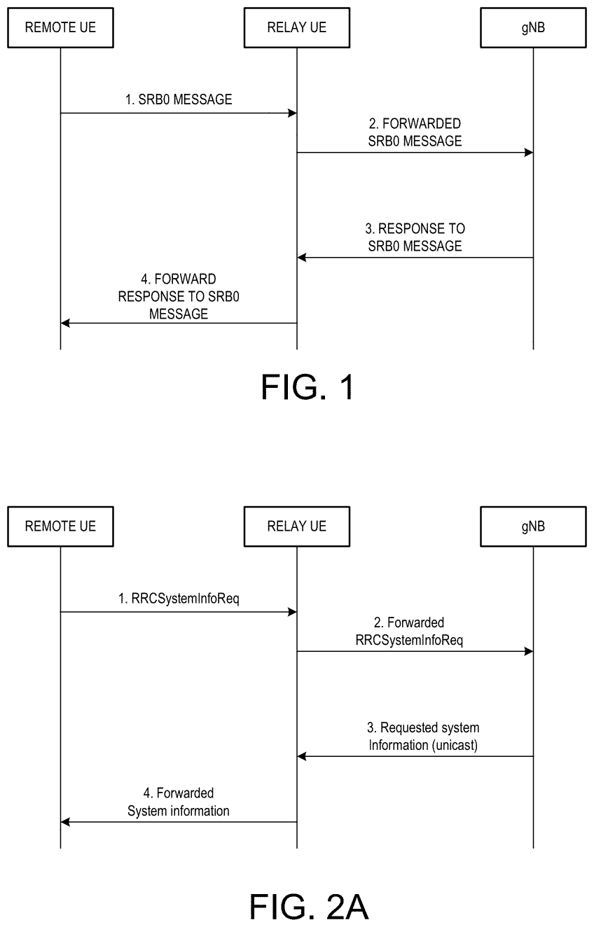

In the following paragraph, we discuss the design of SRB0 transmission according to the exemplary signaling flow as illustrated in FIG. 1. To be specific, we can divide the procedure into 4 steps. In step 1, the remote UE transmit SRB0 message to relay UE. In step 2, the relay UE forwards the SRB0 message of remote UE to the base station. In step 3, the base station provides the response to the SRB0—the response is transmitted to the relay UE. And finally in step 4, the relay UE forwards the response to SRB0 from the base station to the remote UE. There are different ways for the SRB0 message transmission from Remote UE to gNB. In one embodiment, the SRB0 message (e.g. RRCSetupRequest) can go through adaptation layer (at both Uu and PC5, or only at Uu), and in this case, the adaptation layer header is added into the data packet encapsulating SRB0 message by Remote UE. When the gNB performs the response for the SRB0 message, the response message can also go through adaptation layer (at both Uu and PC5, or only at Uu) in case of unicast based response. In one embodiment, the SRB0 message does not go through adaptation layer (at both Uu and PC5, or only at Uu), since there is no RRC connection established between Remote UE and gNB. However, this message may be carried by DCCH over Uu between Relay and gNB, instead of CCCH. This means a specific Uu logical channel needs to be configured for this type of common SRB0 message transmission from Remote UE(s). When the gNB performs the response for the SRB0 message, the response message does not go through adaptation layer (at both Uu and PC5, or only at Uu) in case of unicast-based response.

1. [Step 1] Transmission of SRB0 Message from Remote UE to Relay UE

1-1. Remote UE ID

Over PC5 interface, the remote UE initiates the SRB0 transmission by sending the SRB0 message to relay UE for relay. In one embodiment, the remote UE explicitly indicates its remote UE ID along with the SRB0 message transmitted to relay UE.

In one embodiment, remote UE ID may be included in the MAC level of the SL MAC PDU carrying the SRB0 message, e.g. in the MAC subheader of this RLC SDU including the SRB0 message, or in the MAC header of the SL MAC PDU including the SRB0 message, or in a MAC CE of this SL MAC PDU carrying SRB0 message

In one embodiment, remote UE ID may be included in the adaptation layer header associated with this SRB0 message.

In one embodiment, the remote UE does not include its remote UE ID along with the SRB0 message transmitted to the relay UE. For example, after receiving the SL MAC PDU including SRB0 message, relay UE considers the source UE ID of this MAC PDU (i.e. L2 ID of this remote UE in sidelink communication) as the remote UE.

1-2. Bearer and Logical Channel Mapping

The transmission of SRB0 message over PC5 interface from remote UE to relay UE may be based on a default bearer and/or default RLC channel. The default bearer/RLC channel may be established upon confirmation of the permission to perform SL relay between the remote UE and the relay UE, e.g. an RLC channel can be set up when the relay UE is authorised for relaying.

As mentioned, the default or specified RLC channel for relaying SRB0 can be setup upon relay permission is confirmed. To establish the RLC channel for SRB0 transmission, there are several possible approaches.

In one example, the relay UE and remote UE configure the RLC channel according to the default or specified configuration without additional signaling exchange between remote UE and relay UE. For instance, in the remote UE side, the default/specified RLC channel for SRB0 transmission is established (1) upon relay is authorized, or (2) upon transmission of SRB0 to the relay UE. For instance, in the relay UE side, the default/specified RLC channel for SRB0 reception may be established (1) upon relay is authorized, or (2) upon reception of SRB0 from the remote UE.

In one example, the remote UE configure the SL bearer/SL RLC channel for SRB0 transmission according to one of the configuration from pre-configuration, specified configuration, or NW configuration. The NW configuration may come from SIB or dedicated signaling. For example, the remote UE may be in coverage before or upon SRB0 transmission. For example, the remote UE can acquire the configuration for SRB0 transmission from the relay UE before transmitting SRB0.

In another example, remote UE and relay UE has signaling handshake to configure bi-directional RLC/bearer configuration for Uu SRB0 transmission. The procedure for bi-directional configuration could be similar to how bi-directional sidelink radio bearer is configured between two UE in NR-V2X. For example, one of the relay UE/remote UE initiates the transmission of PC5-RRC message (e.g. configuration carried by RRCReconfigurationSidelink message) to inform peer UE (remote UE/relay UE) the suitable RLC/MAC/PHY configuration for relaying SRB0 over PC5 interface. After receiving the reconfiguration message, the peer UE configures accordingly and then reply the relay UE/remote UE with a confirmation (e.g. response carried by RRCReconfigurationCompleteSidelink message). After receiving the confirmation, the relay UE/remote UE configures its own RLC/MAC/PHY configuration for SRB0 transmission.

Remote UE may also explicitly indicate the message type (e.g. radio bearer ID) associated with the SRB0 message, e.g. indicated in the MAC subheader of this RLC SDU including the SRB0 message, or may be included in the adaptation layer header associated with this SRB0 message (if adaptation layer header is present).

Over PC5 interface, a remote UE may use a PC5-RRC message (e.g. RRCReconfigurationSidelink) as a container to deliver the SRB0 message to relay UE. After relay UE receives the PC5-RRC message, relay UE reply the remote UE with a confirm message (e.g. RRCReconfigurationCompleteSidelink) and then forwards the contained SRB0 message to the base station.

Another embodiment is that remote UE transmits the SRB0 message via an existing or a new sidelink radio bearer. For example, the SRB0 message may be carried by existing SL-SRB3 (i.e. for PC5-RRC message), or can be carried by a new SL-SRB which is dedicated for handling Uu SRBs or is dedicated for handling Uu SRB0.

In one embodiment, the SRB0 message is carried by SCCH (sidelink common control channel) over PC5.

In one embodiment, the SRB0 message is carried by a sidelink logical channel over PC5, wherein the sidelink logical channel is dedicated for carrying relay traffic, or is dedicated for carrying relay traffic for control signaling.

2. [Step 2] Forwarding SRB0 Message from Relay UE to the Base Station

After receiving the SRB0 message, the relay UE can base on the RLC channel, logical channel, bearer, remote UE ID, or adaptation layer header to determine whether to forward the message to the base station.

2-1. Remote UE ID

To forward the SRB0 message, the relay UE determines what information should be carried along with the forwarded message. In one embodiment, the relay UE indicates the remote UE ID associated with the forwarded SRB0 message. In one embodiment, the relay UE does not indicate the remote UE ID associated with the forwarded SRB0 message.

If relay UE indicates remote UE ID associated with the SRB0 message of remote UE ID, there are several ways to configure the content of remote UE ID.

In one embodiment, the remote UE ID to be sent to gNB is the same as the remote UE ID of the SRB0 message forwarded from remote UE to relay UE.

In one embodiment, the remote UE ID to be sent to gNB is one-to-one mapping to the remote UE ID of the SRB0 message forwarded from remote UE to relay UE. For example, a remote UE may have a local ID for relay, e.g. assigned by the relay UE. After receiving the SRB0 message from the remote UE, the relay UE transmit the remote UE ID of the remote UE together with the forwarded SRB0 to the base station, wherein the remote UE ID is translated from the local ID and the remote UE ID may be recognizable to the base station. For example, the NW-recognizable ID may be the destination ID, which is used in sidelink communication to indicate the peer UE.

In one embodiment, the remote UE ID to be sent to gNB is temporarily determined by the relay UE. For example, the temporary remote UE ID is just used to identify whether the later on received response from the NW is for the remote UE who initiates the SRB0 message transmission. The relay UE keeps the mapping between the remote UE and the temporary remote UE ID. After relay UE receives the response associated with the temporary remote UE ID, the relay UE forwards the response to the correct remote UE mapped to the temporary remote UE ID. After relay UE forwards the response to the SRB0 message to remote UE, the temporary remote UE ID may or may not be used for transmission of following-up traffic of this remote UE. For example, after SRB0 transmission, the remote UE may already be configured with a new ID (e.g. could be the same or different form C-RNTI). In this way, after SRB0 transmission, the relay UE can then discard the temporary remote UE ID and update the mapping between the remote UE ID and the destination UE ID of this remote UE in PC5 interface.

Remote UE ID forwarded by the relay UE to the base stations may be located in several candidate places.

In one embodiment, relay UE adds the adaptation layer header to the forwarded SRB0 message. The adaptation layer header may include remote UE ID and/or bearer ID (or equivalent information to indicate the RB type).

In one embodiment, the remote UE ID is included in the MAC subheader associated with the RLC SDU including the forwarded SRB0 message.

In one embodiment, the remote UE ID is included in the MAC header of the UL MAC PDU which includes the forwarded SRB0 message.

In one embodiment, remote UE ID is carried as a MAC CE in the same MAC PDU together with the RLC SDU carrying SRB0 message.

In one embodiment, relay UE does not multiplex SRB0 from the remote UE and data from the relay UE itself or from other remote UE into the same MAC PDU.

In one embodiment, relay UE does not multiplex data from the remote UE and data from the relay UE itself or from other remote UE into the same MAC PDU.

2-2 Transmission Format

The forwarded SRB0 message may be transmitted in several ways.

In one embodiment, the SRB0 message is contained in a RRC message on UL-DCCH of this relay UE. That is, relay UE uses an RRC message as a container to include the SRB0 message of remote UE. The RRC message can be the extension of SUI (sidelinkUEInformation) or UAI (UEAssistanceInformation), or can be a new UL RRC message used for reporting relay related information.

In one embodiment, relay UE adds the adaptation layer header to the forwarded SRB0 message. The adaptation layer header may include remote UE ID and/or bearer ID (or equivalent information to indicate the RB type).

In one embodiment, relay UE uses MAC-level indication header or MAC subheader or MAC CE to identify whether a RLC SDU is for SL relay and/or whether a RLC SDU is for SRB0 transmission of a remote UE.

In one example, MAC subheader can indicate whether the associated RLC SDU is for SL relay, e.g. using one or several bits as indicator in the MAC subheader or use specific logical channel ID range to indicate SL relay traffic. One alternative is that the remote UE ID is explicitly indicated in the MAC subheader, i.e. a different MAC subheader format from UL/DL MAC subheader. Another alternative is that the remote UE ID is included as a MAC CE in the MAC payload right close to (e.g. before) other RLC SDU(s) of the same remote UE.

In one example, MAC header can indicate whether a MAC PDU is for SL relay, e.g. using one or several bits as indicator in the MAC header or use specific logical channel ID range to indicate SL relay traffic. One alternative is that the remote UE ID is explicitly indicated in the MAC header, i.e. a different MAC header format from UL/DL MAC header. Another alternative is that the remote UE ID is included as a MAC CE in this MAC PDU.

The RLC channel, i.e. Uu UL logical channel, used for relay UE to transmit/forward the SRB0 message from remote UE can apply default/specified configuration, or apply NW configuration from SIB or dedicated signaling. The RLC channel can be established upon the relay UE is authorized to provide relay service, upon receiving the request of RLC channel/logical channel establishment from the remote UE, upon reception of the SRB0 message from the remote UE, or upon the initiation to forwarding the SRB0 message.

3. [Step 3] Response to SRB0 Message from the Base Station

After receiving the forwarded SRB0 message, the base station would determine how to provide response to the SRB0 message. How base station performs response depends on the intention of the RRC procedure which triggering the SRB0 transmission over SL relay.

3-1. Response to SRB0 for On-Demand System Information Request

In 3GPP Rel-15, a UE in RRC_IDLE or RRC_INACTIVE can request on-demand system information via triggering RACH procedure without the need to enter RRC_CONNECTED. Further, in 3GPP Rel-16, a UE in RRC_CONNECTED can send a RRC message on UL-DCCH to request system information. Since we are considering the SRB0 transmission, in this invention we consider only the case that a UE in RRC_IDLE/RRC_INACTIVE requests for on-demand system information.

When a remote UE in RRC_IDLE/RRC_INACTIVE has on-demand system information to acquire and sends out RRCSystemInfoRequest, relay UE forwards this message to the base station. There are several ways for the bases station to provide the response and/or the requested system information.

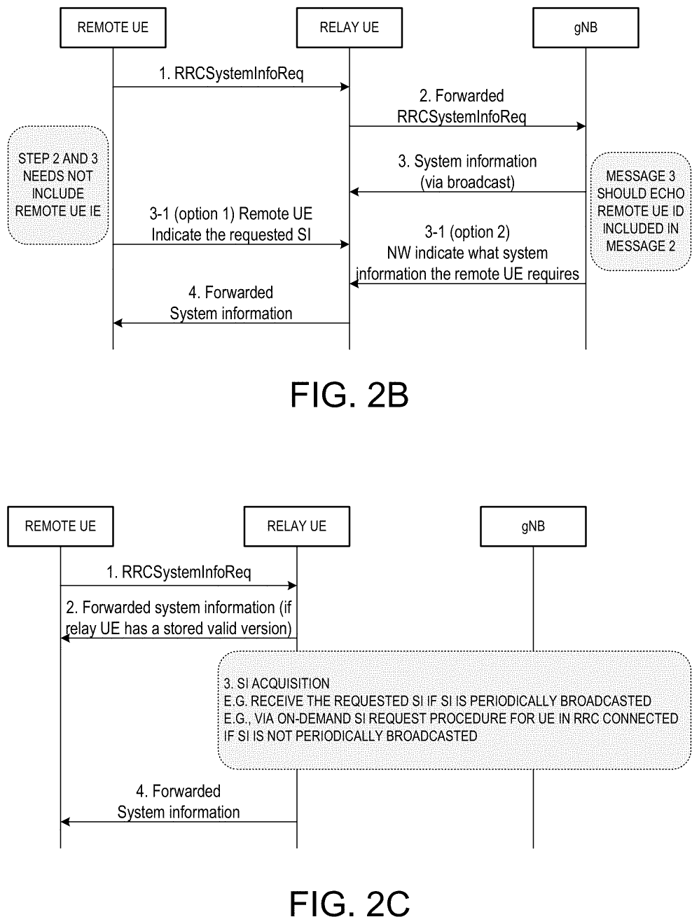

In one embodiment, the SRB0 message forwarded to the base station includes remote UE ID, and, as a response, the base station provides system information always in a unicasted manner (e.g. transmitted via a RRC message such as RRC Reconfiguration message). In addition to the system information, in the same MAC PDU or RRC message, base station indicates the remote UE ID which is same as remote UE ID included in the SRB0 message forwarded to the base station. After relay UE receives the response, relay UE forwards the response to the remote UE matching the remote UE ID. Note that as we mentioned before, the remote UE ID can be a NW-recognizable ID such as C-RNTI, or can just be a local ID which is meaningless to the NW but can be used for the relay UE to identify the remote UE. The signaling flow is illustrated in FIG. 2(a).

In one embodiment, the SRB0 message forwarded to the base station includes remote UE ID, and, as a response, the base station provides system information always in a broadcasted manner. Since the relay UE does not know the purpose of forwarded SRB0, relay UE does not know what on-demand system information should be forwarded to the remote UE. To inform relay UE of the requested system information, there are several possible methods, as illustrated in FIG. 2(b). In one embodiment, when the Relay UE is not aware which Remote UE initiated the On-Demand SI request and he receives the SIB via broadcast based reception from gNB, then he can forward the SIBs to all the connected Remote UEs.

In one embodiment, the relay UE looks into the SRB0 message for system information request. Therefore, relay UE knows what system information the relay UE wants, and thus there is no need for gNB or the remote UE to inform relay UE which system information is requested by which remote UE.

In one example, in addition to the request sent to the base station, the remote UE sends a request to relay UE.

In one example, the base station sends an additional message to the relay UE, instructing the relay UE to forward the requested system information to remote UE. Note that since the forwarded SRB0 includes UE ID, the base station knows what system information the remote UE wants.

In one embodiment, the SRB0 message forwarded to the base station includes remote UE ID, and, as a response, the base station can provide system information in either a unicasted manner or a broadcast manner. Then, those requested system information transmitted via unicast can be forwarded to the remote UE according to the remote UE ID, and those requested system information transmitted via broadcast, as we mentioned above, requires an additional reminder (from either remote UE or the base station as aforementioned) to request the relay UE to forward the requested system information.

In one embodiment, the SRB0 message forwarded to the base station does not includes remote UE ID. In this case, the base station can provide the requested system information to the relay UE via either or both of unicast and broadcast. Since the base station does not exactly know which remote UE associated with this relay UE sends the on-demand system information request, the remote UE who initiates the on-demand system information request should send an additional request to the relay UE asking for forwarding the desired system information.

Note that in the embodiment mentioned above, additional request to the relay UE is needed if the remote UE ID is not included in the SLRB forwarded to the base station, or if the base station determines to or has the flexibility to provide the requested system information via response.

In fact, R16 mechanism are already available for a relay UE to request on-demand system information. So, if we intend to reuse legacy procedure, and if we support the flexibility for NW to provide system information to remote UE via broadcast, an alternative procedure would be as follows, as illustrated in FIG. 2(c). First, a remote UE sends a system information request to the relay UE (e.g. via a new or existing PC5-RRC message for on-demand system information request). Secondly, the relay UE provide the requested system information (e.g. via a PC5-RRC message such as RRCReconfigurationSidelink). If the relay UE has no valid stored version for the requested on-demand SI, the relay UE is triggered to acquire on-demand system information. For example, if the requested system information is broadcasting, the relay UE apply R15 procedure to acquire it; if the requested system information is provided on demand, the relay UE apply R16 procedure to acquire it, i.e. on-demand system information request procedure for a UE in RRC_CONNECTED.

Whether a remote UE can send system information request to a relay UE asking for system information may depend on the association between remote UE and relay UE.

In one embodiment, a remote UE can send system information request to a relay UE only when the remote UE has selected the relay UE for L2 relay.

In one embodiment, a remote UE can send system information request to a relay UE only when the remote UE has established a PC5 RRC connection with the relay UE.

In one embodiment, a remote UE can send system information request to a relay UE even if the remote UE has not established a PC5 RRC connection with the relay UE.

What system information a remote UE can require from a relay UE may also depend on the association between remote UE and relay UE

In one embodiment, if a remote UE is RRC_CONNECTED via L2 relay of the relay UE, this remote UE can acquire all kinds of system information via end-to-end RRC message (e.g. DedicatedSlBRequest) over DCCH to request specific SIBs.

In one embodiment, if a remote UE is RRC_IDLE/RRC_INACTIVE via L2 relay of the relay UE, this remote UE can acquire all kinds of system information by sending a request to the relay UE, e.g. as the signaling flow showed in FIG. 2(c).

In one embodiment, if a remote UE is not (yet) associated with the relay UE for SL relay, this remote UE can only request (if allowed to request) some essential system information from the relay UE, e.g. MIB or SIB1 or specific SIB for sidelink configuration (e.g. for Sidelink relay or for NR-V2X).

In one embodiment, there is a prohibit timer to control the frequency a remote UE sends system information request to the base station, to a relay UE, or to an in-coverage destination UE. For a relay UE, the timer is separately maintained for the network or for a relay/destination UE. The timer is started when the relay UE transmits system information request. The timer may or may not be stopped when UE receive the requested system information from the base station or from a relay/destination UE. When the prohibit timer for the network or for a relay/destination UE is running, the relay UE does not send system information request to the network or to the relay/destination UE.

In one embodiment, a relay UE is configured with a timer to control the response to system information request. The timer is kept per relay UE or per UE who sends system information request to this relay UE. When a relay UE provides system information to any UE/to a specific UE, the timer specific to all UEs/this requesting UE is started. Before the timer expires, the relay UE does not provide system information to any UE/this requesting UE.

3-2. Response to SRB0 for RRC Connection Management

For UE-specific RRC connection management (i.e. RRCSetupRequest, RRCResumeRequest, and RRCRestablishmentRequest), the response to SRB0 should include the remote UE ID, so that relay UE knows which remote UE the response message should be forwarded to.

3-2-1 Remote UE ID Carried by Response to SRB0

The response to SRB0 message received by the base station can be put in one of several locations.

In one embodiment, the remote UE ID can be included the adaptation layer header.

In one embodiment, the remote UE ID can be included the MAC subheader of the RLC SDU which includes the response to the forwarded SRB0 message.

In one embodiment, the remote UE ID can be included the MAC header of the DL MAC PDU which includes the response to the forwarded SRB0 message.

In one embodiment, the remote UE ID included in the response to SRB0 message is the same as the remote UE ID included in the forwarded SRB0 message from relay to the base station.

3-2-2 C-RNTI Carried by RRCSetup and RRCResume for Remote UE

In addition to the remote UE ID, which is used for the relay UE to identify which remote UE the traffic belongs to, the base station can further provide C-RNTI for the remote UE in RRC_IDLE/RRC_INACTIVE who initiates RRCSetup/RRCResume procedure and transits to RRC_CONNECTED.

In one embodiment, the response to SRB0 which requests for entering RRC_CONNECTED includes both the remote UE ID as indicated in SRB0 forwarded to the base station, and the C-RNTI the remote UE is assigned with.

In one embodiment, starting from SRB 1 transmission, relay UE and the base station identify the remote UE by the assigned C-RNTI. In other words, after SRB0, remote UE ID is equivalent to C-RNTI; while during SRB0 transmission/reception when UE is not RRC_CONNECTED, C-RNTI is not yet assigned and the remote UE ID is selected by the remote UE or relay UE.

In one embodiment, after SRB0 transmission, the relay UE and the base station still uses the remote UE ID selected in SRB0 phase for communication. Note that the remote UE can be identified by either C-RNTI or relay UE (ID) plus remote UE ID. The C-RNTI of a remote UE may be included in the RRCSetup/RRCResume message transmitted by the base station and thus C-RNTI is invisible to the relay UE.

In case after SRB0 transmission, the relay UE and the base station will use C-RNTI to identify the remote UE, relay UE needs to know what C-RNTI value is used by the remote UE.

In one embodiment, gNB includes the C-RNTI value together with the response to SRB0 in the same MAC PDU, and thus the relay UE knows the C-RNTI value upon reception of response to SRB0.

In one embodiment, gNB can send signaling to relay UE to reconfigure the ID of a remote UE as C-RNTI.

In one embodiment, the remote UE can inform relay UE of the remote UE ID change after remote UE receives the SRB0 response.

In one embodiment, C-RNTI is transmitted to the remote UE after SRB0 transmission, e.g. in SRB1 after remote UE receives response to SRB0 message.

3-2-3 Transmission Format for the Response to SRB0 of Remote UE

The response to SRB0 may be transmitted in several ways.

In one embodiment, the base station deliver the SRB0 response to the relay UE via RRC message on DL-DCCH. For example, the response may be put into a RRC message container such as RRCReconfiguration message.

In one embodiment, there is Uu DL logical channel applicable for the relay UE to receive the response to SRB0 from the base station. The Uu DL logical channel for reception of SRB0 response can be configured by the network, e.g. through pre-configuration, specified configuration, SIB, or dedicated signaling. The Uu DL logical channel may be established upon authorized to provide relay service, upon reception of SRB0 message, upon transmission of the forwarded SRB0 message, or upon reception of the SBR0 response from the base station.

4. [Step 4] Relay UE Forwards the SRB0 Response from the Base Station to Remote UE

4-1 Bearer Mapping and Configuration

During the SRB0 transmission as mentioned before, there may already have default/specified RLC channel established for transmission of SRB0. The RLC channel can be established in a bi-directional approach, and thus when the remote UE transmit SRB0, the RLC channel for the remote UE to receive the SRB0 is already ready.

In one embodiment, the RLC/MAC/PHY configuration over PC5 for the relay UE to transmit the SRB0 response to remote UE is same as the configuration for the remote UE to send SRB0 in the previous step (step 1).

In one embodiment, the SRB0 response forwarded by the relay UE to the remote UE is carried by a PC5-RRC message, e.g., use PC5-RRC message as a container to include the message for Uu SRB0.

In one embodiment, the SRB0 response forwarded by the relay UE to the remote UE is carried by an existing SL-SRB (e.g. SL-SRB3), or is carried by a new SL-SRB which is dedicated for relaying Uu-SRB or Uu-SRB0.

In one embodiment, the SRB0 response forwarded by the relay UE to the remote UE is carried by a sidelink logical channel dedicated for relaying Uu traffic, or is dedicated for relaying Uu control signaling.

In one embodiment, the SRB0 response forwarded by the relay UE to the remote UE is carried by SCCH (sidelink common control channel) over PC5.

In one embodiment, the RLC/MAC/PHY configuration over PC5 for the relay UE to transmit the SRB0 response to remote UE is different from configuration for the remote UE to send SRB0 in the previous step (step 1). For example, the base station may provide the relay UE with reconfiguration message (e.g. RRC reconfiguration sidelink message) to reconfigure the PC5 link between the remote UE and relay UE. If base station sends PC5 reconfiguration message earlier than or together with the SRB0 response, then SRB0 response may be transmitted with new configuration and/or bearer mapping. Otherwise, if the PC5 link reconfiguration message is transmitted later than the SRB0 response, the SRB0 response transmitted to the remote UE may apply similar approach/configuration as the way the remote UE sends the SRB0 (in step 1).

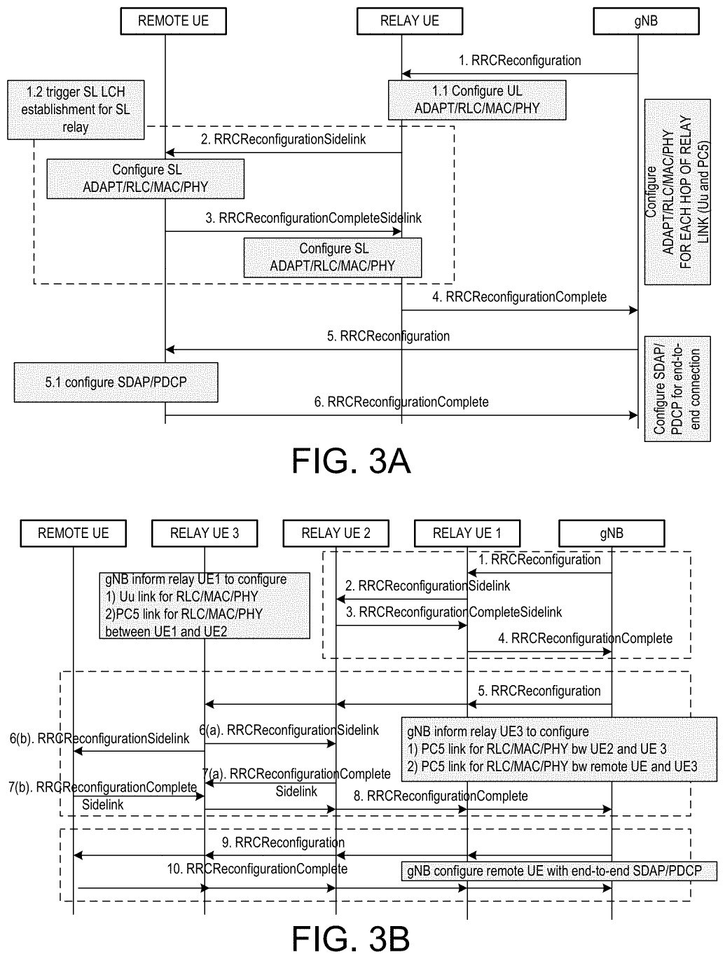

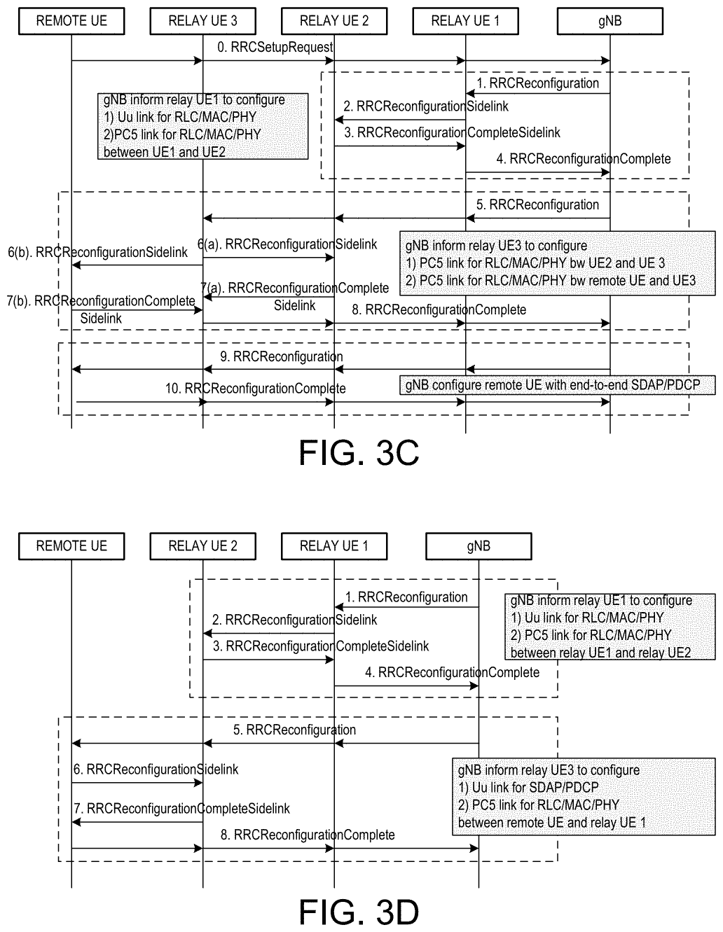

The procedure for the base station to reconfigure PC5 RLC/MAC/PHY configuration, as illustrated in FIG. 3(a) can be as follows: upon receiving the RRCReconfiguration message from the base station, the relay UE sends a RRCReconfigurationSidelink message which includes the RLC/MAC/PHY configuration provided in RRCReconfiguration message to the remote UE. The remote UE applies the RLC/MAC/PHY configuration as provided by the relay UE, and reply with a RRCReconfigurationCompleteSidelink message. After receiving the RRCReconfigurationCompleteSidelink message, the relay UE then updates its own RLC/MAC/PHY configuration. After the PC5 link configuration is updated, the relay UE then forwards the SRB0.

5. Per Link Reconfiguration

To support L2 UE-to-NW relay, end-to-end connection should be established before data transmission. What configuration is used for SRB0 transmission, as we mentioned before, depends on whether the base station reconfigure per link configuration upon or after the establishment of end-to-end connection.

In one embodiment, the base station reconfigure per link configuration upon the establishment of end-to-end connection. In one example, the base station sends reconfiguration message to one or more relay UEs before the base station sends the SRB0 response to remote UE. In another example, the base station piggyback the SRB0 response on the RRCReconfiguration for the relay UE. After relay UE receives the RRCReconfiguration message comprising the SRB0 response, the relay UE reconfiguration the PC5 link before forwarding the SRB0 response on the PC5 link to be reconfigured.

In one embodiment, the base station reconfigure per link configuration after the establishment of end-to-end connection. For example, after remote UE receives the response of SRB0 from the base station, the remote UE enters RRC_CONNECTED and considers the end-to-end connection successfully established. And, after providing response to SRB0 message, the base station send reconfiguration message to one or more relay UEs to reconfigure one or more link for relay.

To update the link configuration for relay, the base station can send RRC message (such as RRC reconfiguration message) for reconfiguring links. The base station may reconfigure link configuration for relay upon receiving the SRB0 (for RRC setup request, for RRC resume request, or for RRC reestablishment request) or upon addition or modification of Uu DRB (data radio bearer).

In one embodiment, the base station sends RRC reconfiguration message to the relay UE (UE-to-NW relay UE), as illustrated in FIG. 3(a). The reconfiguration message includes two parts: first part is for ADAPT/RLC/MAC/PHY configuration for Uu interface, and the second part is for (ADAPT)/RLC/MAC/PHY configuration for PC5 interface linked to the next hop, which is the remote UE in the single-hop scenario and is another relay UE in the multi-hop scenario. After receiving the RRC reconfiguration message, the relay UE reconfigure its Uu link based on received Uu configuration, and, as a response, the relay UE reply to the base station with a response message (e.g. RRCReconfigurationComplete). Moreover, based on the PC5 configuration from the RRCReconfiguration received on Uu, the relay UE is triggered to transmit an RRCReconfigurationSidelink message to the next-hop UE. The next-hop UE, after receiving the RRCReconfigurationSidelink message, reconfigure its (ADAPT)/RLC/MAC/PHY configuration for the PC5 link towards the relay UE according to the configuration included in the RRCReconfigurationSidelink message, and then reply with a confirm message (e.g. via RRCReconfigurationCompleteSidelink). Upon receiving the confirm message, this relay UE then apply the (ADAPT)/RLC/MAC/PHY configuration for the PC5 link towards the next-hop UE. By this way, the bi-directional link reconfiguration is completed. Note that in another embodiment, the relay UE may reconfigure the (ADAPT)/RLC/MAC/PHY configuration earlier than the next-hop UE does, e.g. before the reception of the confirmation message from the next-hop UE, or upon reception of (ADAPT)/RLC/MAC/PHY configuration from the base station.

In one embodiment, the base station uses separate reconfiguration messages to provide the relay UE with ADAPT/RLC/MAC/PHY configuration for Uu link and (ADAPT)/RLC/MAC/PHY configuration for PC5 link.

In one embodiment, the base station sends RRC reconfiguration message to a relay UE in a multi-hop scenario, wherein the relay UE does not directly access to the base station, e.g. this relay UE connects with the prior-hop UE and the next-hop UE via PC5 interface, as the relay UE 3 illustrated in FIG. 3(b) and FIG. 3(c). In FIG. 3(b), we assume relay UE 1, relay UE 2, relay UE 3, and remote UE already establish their own end-to-end connection to the base station. In this case, the RRC reconfiguration message may provide ADAPT/RLC/MAC/PHY configuration for one or more PC5 link. Upon receiving the RRC reconfiguration message, which is transmitted by the base station and be forwarded by other relay UE, this relay UE then trigger reconfiguration message over sidelink (e.g. RRCReconfigurationSidelink message) to reconfigure PC5 link with one of more of its upstreaming/downstreaming peer UEs. As illustrated in FIG. 3(b), relay UE 3 triggers transmission of PC5-RRC message to reconfigure the links towards relay UE 2 and towards remote UE. In FIG. 3(c), we assume relay UE 1, relay UE 2, relay UE 3 already have end-to-end connection, while the remote UE is requesting for RRC connection. We can see the only difference between 3(b) and 3(c) is that in FIG. 3(c), the RRC reconfiguration over each PC5 link is triggered by the RRCSetupRequest message of the remote UE (signaling 0), and the last two signaling message are RRCSetup and RRCSetupComplete rather than RRCReconfiguration and RRCReconfiguration complete.

In one embodiment, the base station sends RRC reconfiguration message to a remote UE via relay UE, as illustrated in FIG. 3(d). In FIG. 3(d), we assume all relay UE and remote UEs are in RRC_CONNECTED, and the base station intends to perform DRB addition for the remote UE. To forward traffic for the added DRB traffic, the base station reconfigure some PC5 link configuration as well. The RRC reconfiguration message for the remote UE may include one of both of two parts: one for SDAP/PDCP (re)configuration for end-to-end Uu connection, and the other part for (ADAPT)/RLC/MAC/PHY over PC5 interface. As a response to the Uu reconfiguration, the remote UE sends out an RRC message as a confirmation (e.g. RRCReconfigurationComplete) to the base station. In contrast, as a response to PC5 reconfiguration, the remote UE should forward the PC5 configuration to the accessed relay UE (e.g. via RRCReconfigurationSidelink). The remote UE should apply the PC5 reconfiguration, and the relay UE should apply the PC5 reconfiguration as well for this link and reply the remote UE with a confirm message (e.g. via RRCReconfigurationCompleteSidelink).

Note that a base station may transmit RRC reconfiguration messages to configure one or several PC5 links with a random order. Multiple procedure for transmitting reconfiguration message towards different relay/remote UE can be run simultaneously. FIGS. 3(a) to 3(d) are just illustration of possible signaling flow, which do not imply that the base station has to trigger RRC reconfiguration procedure for a UE only after RRC reconfiguration procedure for other UEs are completed.

Notice that unlike in NR-V2X, in the SL relay scenario the relayed UL traffic and DL traffic may probably be asymmetric. Therefore, the network may have a flexibility to send reconfiguration message to perform unidirectional or bi-directional link reconfiguration. In one example, the base station send RRC reconfiguration message to a UE, and accordingly this UE and the other UE sharing the same link with this UE (e.g. could be a remote UE or a relay UE) reconfigure the link between them, i.e. bi-directional link reconfiguration. In one embodiment, after a UE receives the RRC reconfiguration message, the relay UE updates the PC5 link configuration towards its peer UE sharing the same relay link. This UE is not triggered by the received RRC reconfiguration message to send RRCReconfigurationSidelink message to its peer UE sharing the same relay link. In one embodiment, after relay UE receives the RRC reconfiguration message, the relay UE does not update its PC5 link configuration towards its peer UE sharing the same relay link, but is triggered to send RRCReconfigurationSidelink message to its peer UE, which triggers its peer UE to reconfigure the PC5 link towards this UE. In one embodiment, the base station may configure two UEs of a relay link with different PC5 configuration towards each other. In one embodiment, it is implicitly or explicitly indicated that the PC5 configuration(s) included in the RRCReconfiguration should be applied by which UE(s) and/or on which link(s).

### DETAILED DESCRIPTION

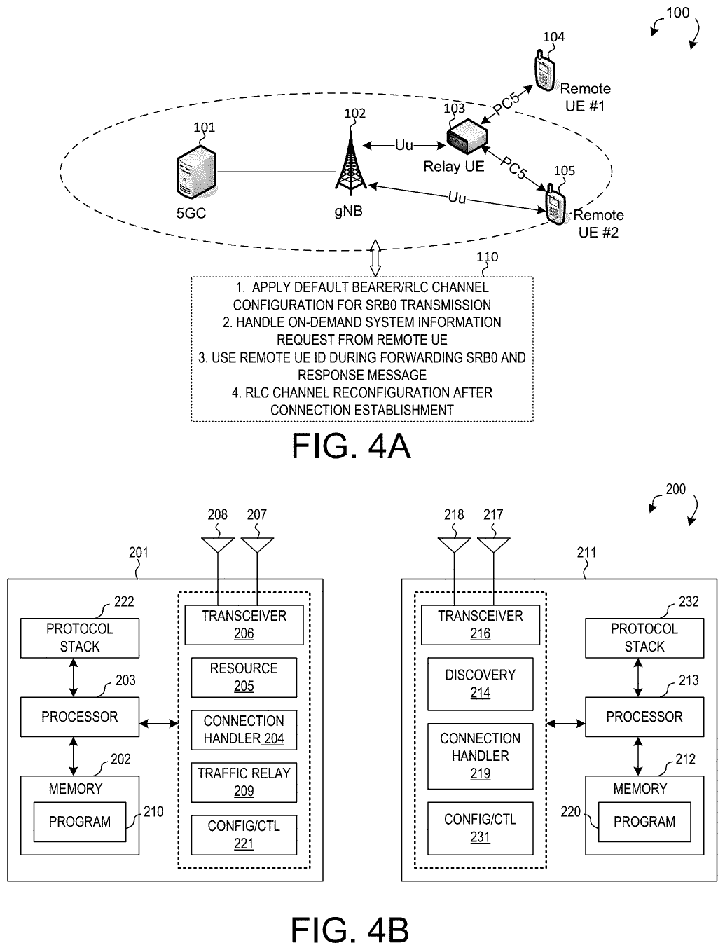

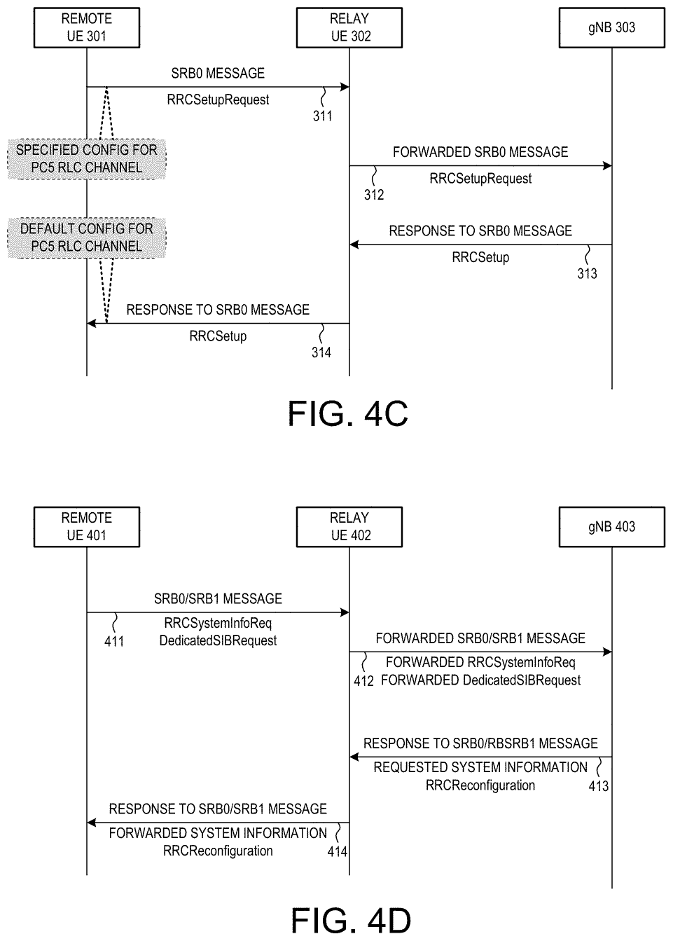

FIG. 4A illustrates a wireless cellular communications system 100 supporting signaling transmission in L2 UE-to-network sidelink relay for a remote UE via a relay UE in accordance with a novel aspect. 5G new radio (NR) mobile communication network 100 comprises a 5G core (5GC) 101, a base station gNB 102, and a plurality of user equipments UE 103, UE 104, and UE 105. For in-coverage UEs, a base station can schedule data traffic over Uu link. For out-of-coverage UEs, a relay UE can schedule data traffic over PC5 (or sidelink (SL)). In FIG. 4A, UE 103 is a radio resource control (RRC)-connected UE that acts as a mobile device relay using PC5 (or SL) to relay data traffic to/from end remote UEs for coverage extension. Remote UE 104 is out of network coverage. Relay UE 103 helps to relay all data traffic for remote UE 104. Remote UE 105 is connected to the network via Uu link but the link quality may be poor. Relay UE 103 helps to relay part or all data traffic for remote UE 105. Relay UE 103 operates to relay communications between UE 104/105 and the network, thus allowing the network to effectively extend its coverage to the remote UEs.

In L2 relay, a relay UE only serves as a hop-by-hop RLC-level router, and thus before data traffic forwarding, a remote UE should establish an end-to-end connection with the gNB via SL relay to create the corresponding end-to-end Uu SDAP/PDCP layer for QoS flow/bearer handling for user plane, and RRC/PDCP layer for control plane. In L2 relay, if a remote UE is not RRC_CONNECTED via SL relay, the remote UE cannot directly send its data traffic. Instead, similar to NR Uu, the remote UE is only allowed to send SRB0-like message before UE enter RRC_CONNECTED state. SRB means signaling radio bearer, and SRB0 message is used to carry essential signaling before RRC connection is established.

In NR Uu, SRB0 is for RRC messages using the CCCH (common control channel) logical channel. A UE will send an UL SRB0 message in the following cases: for establishing a RRC connection (RRCSetupRequest), for resuming a RRC connection (RRCResumeRequest), for re-establishing a RRC connection (RRCReestablishmentRequest), or for on-demand system information request (RRCSystemInfoRequest). In L2 relay, similar to NR Uu, a remote UE has the requirement to maintain a RRC connection (e.g. for setup, for resume, for reestablishment) and to request required system information. However, since in L2 SL relay the SRB0 message is transmitted to the base station via the forwarding of SL relay UE, additional mechanism should be introduced to ensure successful relay.

In accordance with one novel aspect, a method of SRB0 transmission through a relay UE for a remote UE is proposed. For example, mechanisms to ensure that SRB0 message can be forwarded to the base station correctly, e.g., using a suitable bearer or logical channel to send the SRB0 message on both links, i.e., the PC5 link between remote UE and relay UE, and the Uu link between the relay UE and the gNB. For example, mechanisms to ensure that the remote UE can receives the response message from the base station correctly, e.g., correct bearer mapping and routing in the downlink direction over Uu link and PC5 link. As depicted in 110 of FIG. 4A, in one novel aspect, when perform SRB0 transmission over PC5 interface, the relay UE and the remote UE apply default bearer/default RLC channel for SRB0 transmission. In another novel aspect, if the remote UE intends for on-demand system information request, additional signaling is introduced to indicate to the relay UE what system information is forwarded to the remote UE. In another novel aspect, the SRB0 message/response includes a remote UE ID during the forwarding of the SRB0 message/response. In yet another novel aspect, the base station reconfigures per link configuration upon the establishment of an end-to-end connection between the remote UE and the network.

FIG. 4B is a simplified block diagram of wireless devices 201 and 211 in accordance with a novel aspect. For wireless device 201 (e.g., a relay UE), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a remote UE), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 4B, wireless device 201 is a relay UE that includes a protocol stack 222, a resource management circuit 205 for allocating and scheduling sidelink resources, a connection handling circuit 204 for establishing and managing connections, a traffic relay handling controller 209 for relaying all or part of control signalling and/or data traffic for remote UEs, and a control and configuration circuit 221 for providing control and configuration information. Wireless device 211 is a remote UE that includes a protocol stack 232, a relay discovery circuit 214 for discovering relay UEs, a connection handling circuit 219 for establishing and managing connections, and a configuration and control circuit 231. The different functional modules and circuits can be implemented and configured by software, firmware, hardware, and any combination thereof. The function modules and circuits, when executed by the processors 203 and 213 (e.g., via executing program codes 210 and 220), allow relay UE 201 and remote UE 211 to perform embodiments of the present invention accordingly.

FIG. 4C illustrates one embodiment of using a specified/fixed/default configuration to transmit and receive SRB0 in accordance with one novel aspect. In step 311, remote UE 301 transmit a SRB0 message to relay UE 302. In step 312, relay UE 302 forwards the SRB0 message of remote UE 301 to base station gNB 303. In step 313, gNB 303 provides the response to the SRB0 message, and the response is transmitted to relay UE 302. Finally in step 314, relay UE 302 forwards the response to SRB0 from gNB 303 to remote UE 301. There are different ways for the SRB0 message transmission from Remote UE to gNB. In one embodiment, the SRB0 message (e.g. RRCSetupRequest) can go through adaptation layer (at both Uu and PC5, or only at Uu), and in this case, the adaptation layer header is added into the data packet encapsulating SRB0 message by the remote UE. When the gNB performs the response for the SRB0 message, the response message can also go through adaptation layer (at both Uu and PC5, or only at Uu) in case of unicast based response. In another embodiment, the SRB0 message does not go through adaptation layer (at both Uu and PC5, or only at Uu), since there is no RRC connection established between the remote UE and the gNB. However, this message may be carried by DCCH (Dedicated Control Channel) over Uu between the relay UE and gNB, instead of CCCH (Common Control Channel). This means a specific Uu logical channel needs to be configured for this type of common SRB0 message transmission from Remote UE(s). When the gNB performs the response for the SRB0 message, the response message does not go through adaptation layer (at both Uu and PC5, or only at Uu) in case of unicast-based response.

In step 311, the transmission of SRB0 message over PC5 interface from remote UE 301 to relay UE 302 may be based on a default sidelink radio bearer (SL-SRB) and/or a default PC5 RLC channel. The default SL bearer/PC5 RLC channel may be established upon confirmation of the permission to perform SL relay between the remote UE and the relay UE, e.g. an PC5 RLC channel can be set up when the relay UE is authorized for relaying. In other words, the default or specified/fixed PC5 RLC channel for relaying SRB0 can be setup upon relay permission is confirmed. Specified and default SL RLC/MAC layer configurations are configurations of which the details are specified in the 3GPP standard, including logical channel ID, logical channel config, etc. Note that specified configurations are fixed while default configurations can be modified using dedicated signalling. For specified configuration, parameters are specified for unicast of NR sidelink communication, which is used for transmitting sidelink signalling radio bearer, e.g. via PC5-RRC message over PC5-RLC channel. The SL-SRB carrying remote UE's Uu SRB0 message could be SL-SRB3. The Uu SRB0 message can be carried by SCCH (sidelink common control channel) over PC5-RLC channel.

To establish the RLC channel for SRB0 transmission, there are several possible approaches. In one embodiment, the relay UE and remote UE configure the RLC channel according to the default or specified configuration without additional signaling exchange between remote UE and relay UE. For instance, in the remote UE side, the default/specified RLC channel for SRB0 transmission is established (1) upon relay is authorized, or (2) upon transmission of SRB0 to the relay UE. Similarly, in the relay UE side, the default/specified RLC channel for SRB0 reception may be established (1) upon relay is authorized, or (2) upon reception of SRB0 from the remote UE. In another embodiment, the remote UE configures the SL radio bearer/SL RLC channel for SRB0 transmission according to one of the configuration from pre-configuration, specified (fixed) configuration, or from network (NW) configuration. The NW configuration may come from SIB (system information block, which includes system information broadcast by a base station) or dedicated signaling. For example, the remote UE may be in coverage and thus acquire sidelink configuration available for transmitting Uu SRB0 message via SIB or via dedicated NW signaling before or upon SRB0 transmission. For example, the remote UE can acquire the configuration for SRB0 transmission from the relay UE before the transmitting of SRB0. To be specific, the relay UE may provide remote UE with the configuration (system information) required for Uu SRB0 transmission. A relay UE may provide the required configuration by (periodic) broadcast, upon receiving an explicit request from the remote UE, or upon PC5-RRC connection establishment between the remote UE and the relay UE.

Over PC5 interface, a remote UE may use a PC5-RRC message (e.g. RRCReconfigurationSidelink) as a container to deliver the SRB0 message to relay UE. After relay UE receives the PC5-RRC message, relay UE reply the remote UE a confirm message (e.g. RRCReconfigurationCompleteSidelink) and then forwards the contained SRB0 message to the base station. In one embodiment, the remote UE transmits the SRB0 message via an existing or a new sidelink radio bearer. For example, the SRB0 message may be carried by existing SL-SRB3 (i.e. for PC5-RRC message), or can be carried by a new SL-SRB which is dedicated for handling/forwarding Uu SRBs or is dedicated for handling Uu SRB0. In one embodiment, the SRB0 message is carried by SCCH (sidelink common control channel) over PC5.

In step 312, the forwarded SRB0 may be transmitted in several ways. In one embodiment, the SRB0 message is contained in a RRC message on UL-DCCH of this relay UE. That is, relay UE uses an RRC message as a container to include the SRB0 message of remote UE. The RRC message can be the extension of SUI (sidelinkUEInformation) or UAI (UEAssistanceInformation), or can be a new UL RRC message used for reporting relay related information. The Uu UL RLC channel used for relay UE to transmit/forward the SRB0 message from remote UE can apply default configuration, apply specified/fixed configuration, or apply NW configuration from SIB or dedicated signaling. The Uu RLC channel for remote UE's Uu SRB0 forwarding can be established upon the relay UE is authorized to provide relay service, upon receiving the request of RLC channel/logical channel establishment from the remote UE, upon reception of the SRB0 message from the remote UE, or upon the initiation to forwarding the SRB0 message.

In step 313, gNB 303 determines how to provide response to the SRB0 message. How base station performs response depends on the intention of the RRC procedure which triggering the SRB0 transmission over SL relay (e.g., RRCSetup in response to RRCSetupRequest). The response to SRB0 may be transmitted in several ways. In one embodiment, the base station deliver the SRB0 response to the relay UE via RRC message on DL-DCCH over Uu. For example, the response may be put into a RRC message container such as RRCReconfiguration message.

In one embodiment, there is Uu DL logical channel applicable for the relay UE to receive the response to SRB0 from the base station. The message as SRB0 response can be transmitted via a relay-specific/SRB0-specific Uu DL logical channel. The Uu DL logical channel for reception of SRB0 response can be configured by the network (e.g. via pre-configuration, SIB or dedicated signaling) by default configuration, or by specified/fixed configuration. The Uu DL logical channel may be established upon authorized to provide relay service, upon reception of SRB0 message, upon transmission of the forwarded SRB0 message, or upon reception of the SBR0 response from the base station.

In step 314, relay UE 302 forwards the SRB0 response from gNB 303 to remote UE 301. For the delivery of remote UE's SRB1 RRC message such as RRCReestablishment and RRCResume message, default configuration is used for the configuration of PC5 RLC channel. During the SRB0 transmission in step 311, there may already have default/specified RLC channel established for transmission of SRB0. The RLC channel can be established in a bi-directional approach, and thus when the remote UE transmits SRB0, the RLC channel for the remote UE to receive the corresponding SRB0 is already ready, and the RLC channel can then be reused to transmit the message in step 314. In one embodiment, the RLC/MAC/PHY configuration over PC5 for the relay UE to transmit the SRB0 response to remote UE is same as the configuration for the remote UE to send SRB0 in step 311.

In one embodiment, the SRB0 response forwarded by the relay UE to the remote UE is carried by a PC5-RRC message, e.g., use PC5-RRC message as a container to include the message for Uu SRB0. In one embodiment, the SRB0 response forwarded by the relay UE to the remote UE is carried by an existing SL-SRB (e.g. SL-SRB3), or is carried by a new SL-SRB which is dedicated for relaying Uu-SRB or Uu-SRB0. In one embodiment, the SRB0 response forwarded by the relay UE to the remote UE is carried by a sidelink logical channel dedicated for relaying Uu traffic, or is dedicated for relaying Uu control signaling (e.g. for Uu SRB only or for both Uu SRB0 and SRB1). In one embodiment, the SRB0 response forwarded by the relay UE to the remote UE is carried by SCCH (sidelink common control channel) over PC5.

In another embodiment, the RLC/MAC/PHY configuration over PC5 for the relay UE to transmit the SRB0 response to remote UE in step 314 is different from configuration for the remote UE to send SRB0 in step 311. For example, the base station may provide the relay UE with reconfiguration message (e.g. RRC reconfiguration sidelink message) to reconfigure the PC5 link between the remote UE and relay UE. If base station sends PC5 reconfiguration message earlier than or together with the SRB0 response, then SRB0 response may be transmitted with new configuration and/or bearer mapping. Otherwise, if the PC5 link reconfiguration message is transmitted later than the SRB0 response, the SRB0 response transmitted to the remote UE may apply similar approach/configuration as the way the remote UE sends the SRB0 in step 311.

FIG. 4D illustrates one embodiment of SRB0 transmission for remote UE in connected mode to request system information (SI) (in accordance with one novel aspect. For RRC_Connected remote UE, a dedicated SIB request procedure is re-used for the remote UE to request the SI via the relay UE. In step 411, remote UE 401 transmit a SRB0 message (e.g., RRCSystemInfoReq) to relay UE 402. In step 412, relay UE 402 forwards the SRB0 message (e.g., RRCSystemInfoReq) of remote UE 401 to base station gNB 403. In step 413, gNB 403 provides the response to the SRB0 message (e.g., the requested system information), and the response is transmitted to relay UE 402. Finally in step 414, relay UE 402 forwards the response to the SRB0 message (e.g., the requested system information) from gNB 403 to remote UE 401.

In another alternative embodiment, if a remote UE is RRC_CONNECTED via L2 relay of the relay UE, this remote UE can acquire all kinds of system information via end-to-end RRC message (e.g. a DedicatedSlBRequest SRB1 message) over DCCH to request specific SIBs (step 411). In one embodiment, the SRB1 message along with the remote UE ID are forwarded (step 412), and, as a response, the base station provides system information always in a unicasted manner (e.g. the base station transmit the requested system information via a RRC message such as RRC Reconfiguration message to the relay UE (step 413), and the relay UE forwards it to the remote UE (step 414)). In addition to the system information, in the same MAC PDU or RRC message, the base station indicates the remote UE ID which is same as remote UE ID included in the SRB1 message forwarded to the base station. After relay UE receives the response, relay UE forwards the response to the remote UE matching the remote UE ID. Note that the remote UE ID can be a NW-recognizable ID such as C-RNTI, or can just be a local ID which is meaningless to the NW but can be used for the relay UE to identify the remote UE.

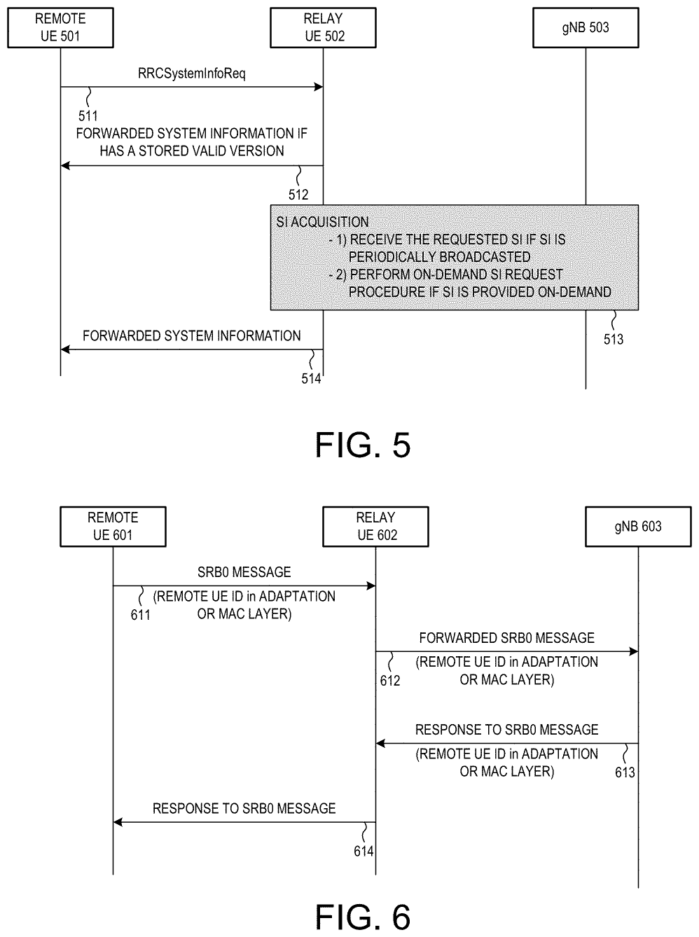

FIG. 5 illustrates one embodiment of SRB0 transmission for remote UE in idle mode to request system information in accordance with one novel aspect. For RRC_Idle/INACTIVE remote UE, remote UE informs relay UE on requested SIB or SI message type(s) via PC5 signaling such as a PC5-RRC message. After receiving the SI request, relay UE triggers legacy SI acquisition procedure according to its own RRC state (if needed) and sends the acquired SIB(s) and/or SI message(s) to remote UE. PC5-RRC message can be used to forward the requested system information via PC5. In step 511, remote UE 501 transmits a SRB0 message (e.g., RRCSystemInfoReq) or a message with the same purpose to relay UE 502, via a new or existing PC5-RRC message/SL SRB for on-demand system information request. Notice that unlike legacy behavior, after relay UE receives the system information request message from the RRC_Idle/INACTIVE remote UE, the relay UE does not directly forward the message to the base station. In step 512, if relay UE 502 has a stored valid version of the requested system information, then relay UE 502 sends the requested system information to relay UE 501.

In step 513, if relay UE 502 does not have valid stored version for the requested system information, then relay UE 502 triggers a legacy SI acquisition procedure. For example, 1) if the requested system information is broadcasting by the base station of the relay UE, the relay UE apply R15 procedure to acquire it, i.e., monitoring specific PDCCH occasion to receive requested SIB(s)/SI message(s) using SI-RNTI; 2) if the requested system information is provided by the base station of the relay UE on demand, and if the relay UE is in RRC_CONNECTED state, the relay UE apply R16 procedure to acquire it, i.e. the relay UE in RRC_CONNECTED state performs on-demand system information request procedure by transmitting DedicatedSlBRequest message to indicate the required SIBs; 3) if the requested system information is provided by the base station of the relay UE on demand, and if the relay UE is in RRC_IDLE/INACTIVE state, the relay UE apply R15 procedure to request system information requested by the remote UE, i.e., the relay UE in RRC IDLE/INACTIVE state trigger RACH procedure to inform the base station of the requested system information. Finally in step 514, relay UE 502 forwards the response to the SRB0 message (e.g., the message to request system information) from gNB 503 to remote UE 501. The response to system information request, which includes the requested system information, can be transmitted via a PC5-RRC message such as RRCReconfigurationSidelink.

FIG. 6 illustrates one embodiment of SRB0 transmission for remote UE with remote UE ID determined by remote UE, relay UE, or gNB. In step 611, remote UE 601 transmit a SRB0 message to relay UE 602. In one embodiment, the remote UE explicitly indicates its remote UE ID along with the SRB0 message transmitted to relay UE. In one embodiment, remote UE ID may be included in the MAC level of the SL MAC PDU carrying the SRB0 message, e.g. in the MAC subheader of the SL MAC subPDU including the SRB0 message, or in the MAC header of the SL MAC PDU including the SRB0 message, or in a MAC CE of this SL MAC PDU carrying SRB0 message. In one embodiment, remote UE ID may be included in the adaptation layer header associated with this MAC subPDU including the SRB0 message.

In step 612, relay UE 602 forwards the SRB0 message of remote UE 601 to base station gNB 603. To forward the SRB0 message, the relay UE determines what information should be carried along with the forwarded message. In one embodiment, the relay UE indicates the remote UE ID associated with the forwarded SRB0 message. In one embodiment, the remote UE ID to be sent to gNB is the same as the remote UE ID of the SRB0 message forwarded from remote UE to relay UE. In one embodiment, the remote UE ID to be sent to gNB is one-to-one mapping to the remote UE ID of the SRB0 message forwarded from the remote UE to the relay UE. For example, remote UE 601 may have a local ID for relay, e.g. assigned by relay UE 602. After receiving the SRB0 message from the remote UE, the relay UE transmit the identity (ID) of the remote UE together with the forwarded SRB0 to the base station, wherein the remote UE ID is translated from the local ID and the remote UE ID may be recognizable to the base station. For example, the NW-recognizable ID may be the destination ID, which is used in sidelink communication to indicate the peer UE.

In one embodiment, the remote UE ID to be sent to gNB 603 is temporarily determined by relay UE 602. For example, the temporary remote UE ID is just used to identify whether the later on received response from the NW is for the remote UE who initiates the SRB0 message transmission. The relay UE keeps the mapping between the remote UE and the temporary remote UE ID. After relay UE receives the response associated with the temporary remote UE ID, the relay UE forwards the response to the correct remote UE mapped to the temporary remote UE ID. After the relay UE forwards the response to the SRB0 message to the remote UE, the temporary remote UE ID may or may not be used for transmission of following-up traffic of this remote UE. For example, after SRB0 transmission, the remote UE may already be configured with a new ID (e.g. could be the same or different from C-RNTI). For example, the gNB can provide C-RNTI in the response to SRB0 message in step 613 when the SRB0 message is RRCSetup, RRCResume, or RRCReestablishment message. In this way, after SRB0 transmission, the relay UE may discard the temporary remote UE ID and store the new ID of the remote UE for routing, e.g. update the mapping between the remote UE ID and the destination UE ID of this remote UE in PC5 interface.

Remote UE ID forwarded by relay UE 602 to gNB 603 may be located in several candidate places. In one embodiment, the relay UE adds the adaptation layer header to the forwarded SRB0 message. The adaptation layer header may include remote UE ID and/or Uu radio bearer ID (or equivalent information to indicate the RB type). In one embodiment, the remote UE ID is included in the MAC subheader associated with the RLC SDU including the forwarded SRB0 message. In one embodiment, the remote UE ID is included in the MAC header of the UL MAC PDU which includes the forwarded SRB0 message. In one embodiment, remote UE ID is carried as a MAC CE in the same MAC PDU together with the RLC SDU carrying SRB0 message. In one embodiment, relay UE does not multiplex SRB0 from the remote UE and data from the relay UE itself or from other remote UE into the same MAC PDU. In one embodiment, relay UE does not multiplex data from the remote UE and data from the relay UE itself or from other remote UE into the same MAC PDU.

In step 613, gNB 603 provides the response to the SRB0 message, and the response is transmitted to relay UE 602. In one embodiment, the remote UE ID can be included the adaptation layer header. In one embodiment, the remote UE ID can be included the MAC subheader of the RLC SDU which includes the response to the forwarded SRB0 message. In one embodiment, the remote UE ID can be included the MAC header of the DL MAC PDU which includes the response to the forwarded SRB0 message. In one embodiment, the remote UE ID included in the response to SRB0 message is the same as the remote UE ID included in the forwarded SRB0 message from relay to the base station. Finally in step 614, relay UE 602 forwards the response to SRB0 from gNB 603 to remote UE 601.

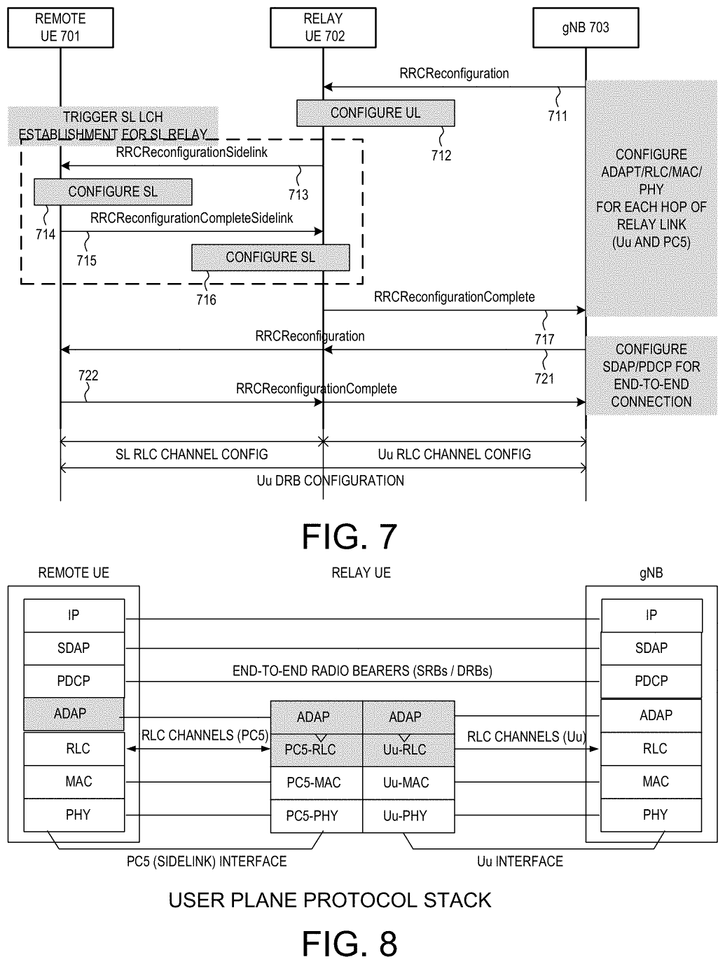

FIG. 7 illustrates one embodiment of PC5 RLC channel configuration and DRB configuration for remote UE after connection establishment. The procedure for the base station to reconfigure PC5 RLC/MAC/PHY configuration can be as follows. In step 711, relay UE 702 receives a RRCReconfiguration message from gNB 703. In step 712, relay UE 702 applies ADAPT/RLC/MAC/PHY Uu configuration as provided by gNB 703. In step 713, relay UE 702 sends a RRCReconfigurationSidelink message which includes the SL RLC/MAC/PHY configuration provided in RRCReconfiguration message to remote UE 701. The remote UE applies SL RLC/MAC/PHY configuration as provided by the relay UE in step 714, and replies a RRCReconfigurationCompleteSidelink message in step 715. In step 716, after receiving RRCReconfigurationCompleteSidelink message, the relay UE then updates its own SL RLC/MAC/PHY configuration for the link between relay UE and remote UE. After updating PC5 link configuration, the relay UE then transmit a message, e.g., RRCReconfigurationComplete message, to gNB 703 in step 717 as a response to gNB's RRCReconfiguration in step 711.

The RRCReconfiguration message for per link configuration (i.e. the Uu link between relay UE and the gNB, and the PC5 link between remote UE and the relay UE) can includes two parts: first part is the Uu ADAPT/RLC/MAC/PHY configuration for Uu interface, and the second part is the SL (ADAPT)/RLC/MAC/PHY configuration for PC5 interface linked to the remote UE. After receiving the RRC reconfiguration message, the relay UE reconfigure its Uu link based on received Uu configuration, and, as a response, the relay UE reply to the base station with a response message (e.g. RRCReconfigurationComplete). Moreover, based on the PC5 configuration included in the RRCReconfiguration received on Uu, the relay UE is triggered to transmit an RRCReconfigurationSidelink message to the remote UE. The remote UE, after receiving the RRCReconfigurationSidelink message, reconfigure its SL(ADAPT)/RLC/MAC/PHY configuration for the PC5 link towards the relay UE according to the configuration included in the RRCReconfigurationSidelink message, and then reply with a confirm message (e.g. via RRCReconfigurationCompleteSidelink). Upon receiving the confirm message, the relay UE then apply the (ADAPT)/RLC/MAC/PHY configuration for the PC5 link towards the remote UE. By this way, the bi-directional PC5 link reconfiguration is completed.

In addition to bi-directional PC5 link (re)configuration, uni-directional PC5 link configuration is also possible. For example, when relay UE receives the RRCReconfiguration message from gNB, if the included SL (Adapt)/RLC/MAC/PHY configuration is only for the relay UE but not for the remote UE, the relay UE may just apply the PC5 configuration, and is not triggered to transmit RRCReconfigurationSidelink message to deliver the PC5 configuration to the remote UE. In another example, when relay UE receives the RRCReconfiguration message from gNB, if the included SL (Adapt)/RLC/MAC/PHY configuration is only for the remote UE but not for the relay UE, the relay UE may just transmit RRCReconfigurationSidelink message to deliver the PC5 configuration to the remote UE, but the relay UE does not apply the PC5 configuration forwarded to the remote UE.

Note that in FIG. 7, relay UE may transmit RRCReconfigurationComplete message in step 717 after the relay UE apply both Uu and PC5 configuration included in the RRCReconfiguration message in step 711. Another implementation is that relay UE may transmit RRCReconfigurationComplete message just after the relay UE apply Uu configuration included in the RRCReconfiguration message in step 711.

The RRCReconfiguration message for end-to-end connection (i.e. between the remote UE and the gNB) may include the Uu SDAP/PDCP configuration. Note that the mentioned RRCReconfiguration message does not include Uu RLC/MAC/PHY configuration for a Uu DRB configuration because there is no direct Uu communication between remote UE and the base station.

In one embodiment, the base station reconfigure per link configuration after the establishment of end-to-end connection. For example, after the remote UE receives the response of SRB0 from the base station, the remote UE enters RRC_CONNECTED and considers the end-to-end connection successfully established. And, after providing response to SRB0 message, the base station send reconfiguration message to one or more relay UEs to reconfigure one or more link for relay. To update the configuration for end-to-end connection, in step 721, the base station can send an RRC message (such as RRC reconfiguration message) for reconfiguring links. In step 722, the remote UE sends an RRCReconfigurationComplete to the gNB.

In one embodiment, the base station may reconfigure the end-to-end configuration for relay upon receiving the SRB0 (for RRC setup request, for RRC resume request, or for RRC reestablishment request) or upon addition or modification of Uu DRB (data radio bearer).

FIG. 8 illustrates a layer 2 (L2) sidelink (SL) relaying architecture for UE-to-network SL relay in accordance with one novel aspect. In case of L2 based SL Relay, relaying is performed above RLC sublayer via Relay UE for both control plane (CP) and user plane (UP) between Remote UE and network. Uu SDAP/PDCP and RRC are terminated between Remote UE and gNB, while RLC, MAC and PHY are terminated in each link (i.e. the link between Remote UE and UE-to-Network Relay UE and the link between UE-to-Network Relay UE and the gNB). An adaptation layer over RLC layer is supported in Uu to perform bearer mapping and it can be also placed over PC5 to perform bearer mapping at sidelink. The adaptation layer between the Relay UE and gNB is able to differentiate between bearers (SRBs, DRBs) of a particular Remote UE. Within a Uu DRB, different Remote UEs and different bearers of the Remote UE can be indicated by additional information included in adaptation layer header. Unlike in L3 relay, the gNB is aware of each remote UE, and thus before the relay UE starts to forward normal data traffic, the end-to-end connection between a remote UE and the gNB should be established first. After establishing the RRC connection via SL relay, the remote UE can then forward data traffic based on the established bearers and the forwarding/router information carried in adaptation layer.

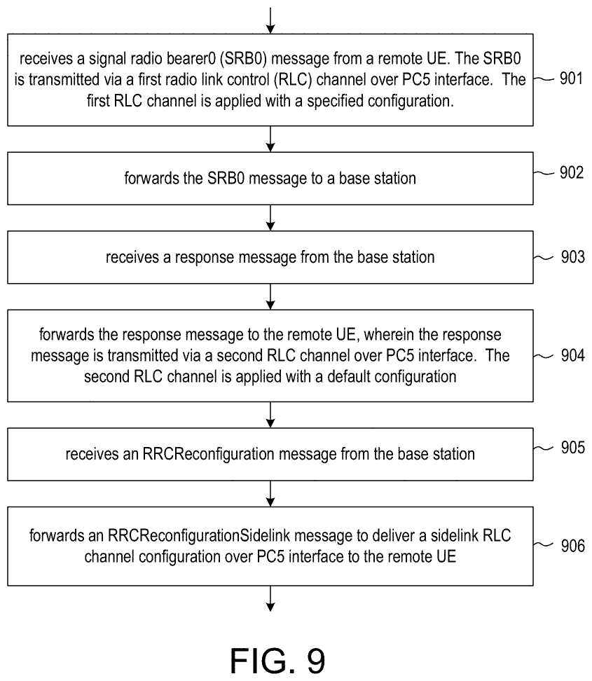

FIG. 9 is a flow chart of a method of SRB0 transmission and reception in L2 UE-to-network relay in accordance with one novel aspect. In step 901, a relay UE receives a signal radio bearer0 (SRB0) message from a remote UE. The SRB0 is transmitted via a first radio link control (RLC) channel over PC5 interface. The first RLC channel is applied with a specified configuration. In step 902, the relay UE forwards the SRB0 message to a base station. In step 903, the relay UE receives a response message from the base station. In step 904, the relay UE forwards the response message to the remote UE, wherein the response message is transmitted via a second RLC channel over PC5 interface. The second RLC channel is applied with a default configuration. In step 905, the relay UE receives an RRCReconfiguration message from the base station. In step 906, the relay UE forwards an RRCReconfigurationSidelink message to deliver a sidelink RLC channel configuration over PC5 interface to the remote UE.

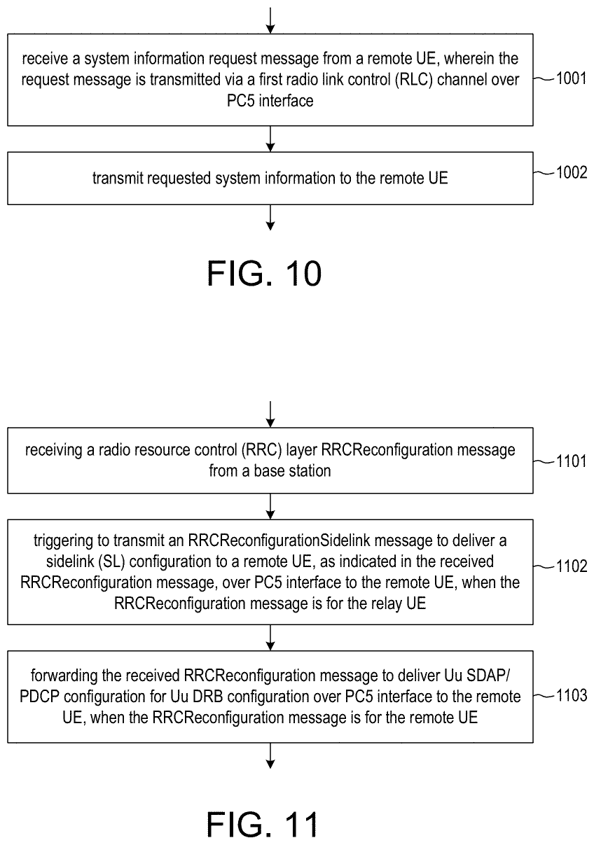

FIG. 10 is a flow chart of a method of system information acquisition for a remote UE in L2 UE-to-network relay in accordance with one novel aspect. In step 1001, a relay UE receives a system information request message from a remote UE, wherein the request message is transmitted via a first radio link control (RLC) channel over PC5 interface. In step 1002, the relay UE transmits requested system information to the remote UE. In one embodiment, the remote UE is in RRC CONNECTED state, and the request message is a DedicatedSlBRequest message. The procedure for the relay UE to handle the request message further comprises: forwarding the request message to a base station; receiving a response message from the base station; and forwarding the response message to the remote UE, wherein the response message is transmitted via a second RLC channel over PC5 interface. In another embodiment, the remote UE is in RRC IDLE state or in RRC INACTIVE state, and the request message is an RRCSystemInfoReq message. The procedure for the relay UE to transmit the requested system information to the remote UE further comprises: transmitting requested system information to the remote UE when the relay UE has a stored valid version of the requested system information; and_otherwise, triggering a system information acquisition procedure to acquire the requested system information when the relay UE does not have the stored valid version of the requested system information.

FIG. 11 is a flow chart of a method PC5 RLC channel configuration and DRB configuration for a remote UE after connection establishment. In step 1101, a relay UE receives a radio resource control (RRC) layer RRCReconfiguration message from a base station. In step 1102, the relay UE triggers to transmit an RRCReconfigurationSidelink message to deliver a sidelink (SL) configuration to a remote UE, as indicated in the received RRCReconfiguration message, over PC5 interface to the remote UE, when the RRCReconfiguration message is for the relay UE. In step 1103, the relay UE forwards the received RRCReconfiguration message to deliver Uu SDAP/PDCP configuration for Uu DRB configuration over PC5 interface to the remote UE, when the RRCReconfiguration message is for the remote UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-16. (canceled)

17. A method by a relay user equipment (UE), comprising:
(a) receiving a signal radio bearer( )(SRB0) message from a remote UE, wherein the SRB0 is transmitted via a first radio link control (RLC) channel over PC5 interface, and wherein the first RLC channel is applied with a specified configuration;
(b) forwarding the SRB0 message to a base station;
(c) receiving a response message from the base station; and
(d) forwarding the response message to the remote UE, wherein the response message is transmitted via a second RLC channel over PC5 interface, and wherein the second RLC channel is applied with a default configuration.

18. The method of claim 17, wherein (b) involves forwarding the SRB0 message via a default RLC channel over Uu interface for SRB0 transmission.

19. The method of claim 17, wherein the SRB0 message in (b) is contained within a radio resource control (RRC) message on a UL-DCCH (uplink dedicated control channel) over Uu.

20. The method of claim 17, wherein the response message in (c) is contained within a radio resource control (RRC) message on a DL-DCCH (downlink dedicated control channel) over Uu.

21. The method of claim 17, wherein the response message in (d) is contained within a radio resource control (RRC) message on a SCCH (sidelink control channel) over PC5 interface.

22. The method of claim 17, wherein the SRB0 message is transmitted together with an ID of the remote UE.

23. The method of claim 22, wherein the ID of the remote UE is determined by the remote UE, the relay UE, or by the base station to identify the remote UE associated with the SRB0 message.

24. The method of claim 22, wherein the ID of the remote UE is included on one of an adaptation layer header, a MAC RLC layer subheader, a MAC control element (CE), a MAC layer header for a MAC PDU.

25. A method by a relay user equipment (UE), comprising:
receiving a system information request message from a remote UE, wherein the request message is transmitted via a first radio link control (RLC) channel over PC5 interface; and
transmitting requested system information to the remote UE.

26. The method of claim 25, wherein the remote UE is in a radio resource control (RRC) CONNECTED state, and wherein the request message is a DedicatedSlBRequest message, and wherein the procedure for the relay UE to handle the request message further comprising:
forwarding the request message to a base station;
receiving a response message from the base station; and
forwarding the response message to the remote UE, wherein the response message is transmitted via a second RLC channel over PC5 interface.

27. The method of claim 25, wherein the remote UE is in an radio resource control (RRC) IDLE state or in RRC INACTIVE state, and wherein the first RLC channel used by the remote UE to send the system information request message applies a specified or a default configuration, and wherein a procedure for the relay UE to transmit the requested system information to the remote UE further comprising:
transmitting the requested system information to the remote UE when the relay UE has a stored valid version of the requested system information; and
otherwise, triggering a system information acquisition procedure to acquire the requested system information when the relay UE does not have the stored valid version of the requested system information.

28. The method of claim 27, wherein the relay UE is in an RRC CONNECTED state, and wherein the system information acquisition procedure further comprising:
transmitting a DedicatedSlBRequest message which indicates the system information requested by the remote UE to a base station;
receiving one or more response messages including the requested system information from the base station; and
forwarding the requested system information to the remote UE, wherein the requested system information is transmitted via a second RLC channel over PC5 interface, and wherein the second RLC channel is applied with a default or a specified configuration.

29. The method of claim 27, wherein the relay UE is in an RRC IDLE state or in an RRC INACTIVE state, and wherein the system information acquisition procedure involves the relay UE performing a random access channel (RACH) procedure when the requested system information is provided by a base station on demand.

30. A method by a relay User Equipment (UE), comprising:
receiving a radio resource control (RRC) layer RRCReconfiguration message from a base station;
triggering to transmit an RRCReconfigurationSidelink message to deliver a sidelink (SL) configuration to a remote UE, as indicated in the received RRCReconfiguration message, over PC5 interface to the remote UE, when the RRCReconfiguration message is for the relay UE; and
forwarding the received RRCReconfiguration message to deliver Uu packet data convergence protocol/service data adaptation protocol (PDCP/SDAP) configuration for Uu data radio bearer (DRB) configuration over PC5 interface to the remote UE, when the RRCReconfiguration message is for the remote UE.

31. The method of claim 30, wherein the RRCReconfigurationSidelink message contains sidelink radio link control/logic channel (SL RLC/LCH) configuration for PC5 RLC channel configuration provided to the remote UE.

32. The method of claim 30, wherein the RRCReconfiguration message provided to the relay UE contains Uu radio link control/logic channel (RLC/LCH) configuration for Uu RLC channel configuration, or contains SL RLC/LCH configuration for SL RLC channel configuration on a link toward the remote UE.
